(19) United States
(12) Patent Application Publication
(10) Pub. No.: US 2011/0032459 A1
(43) Pub. Date: Feb. 10, 2011

(54) LIQUID CRYSTAL DISPLAY

(75) Inventors: Sam-Ho IHM, Yongin-city (KR); Min-Woo Kim, Yongin-city (KR); Jae-Kyung Go, Yongin-city (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung Mobile Display Co., Ltd., Yongin-city (KR)

(21) Appl. No.: 12/848,829

(22) Filed: Aug. 2, 2010

(30) Foreign Application Priority Data
Aug. 6, 2009 (KR) 10-2009-0072361

(51) Int. Cl. G02F 1/1335

(52) U.S. Cl. 349/113; 349/117

(57) ABSTRACT

A liquid crystal display is disclosed. In one embodiment, the display includes i) a lower substrate comprising a lower transmissive region and a lower reflective region, wherein a reflecting layer is formed in the lower reflective region, and wherein the reflective layer has a lens shape which comprises a first concave portion and a first convex portion, ii) an upper substrate comprising an upper transmissive region and an upper reflective region, wherein a first overcoat layer is formed in the upper reflective region, and wherein the first overcoat layer has a lens shape which comprises a second concave portion and a second convex portion and iii) a liquid crystal layer positioned between the lower substrate and the upper substrate.

### CROSS-REFERENCE TO RELATED APPLICATIONS

This application claims priority to and the benefit of Korean Patent Application No. 10-2009-0072361, filed on Aug. 6, 2009, in the Korean Intellectual Property Office, the entire content of which is incorporated herein by reference.

### BACKGROUND

1. Field of the Invention

Embodiments relate to a liquid crystal display, and more particularly, to a transflective liquid crystal display that reflects natural light and transmits artificial light.

2. Discussion of the Related Technology

A liquid crystal display may be divided into a transmission type liquid display device that displays an image using artificial light emitted from the inside and a reflection type liquid display device that displays an image using natural light.

The reflection type liquid crystal display is mainly used in displays such as a clock, a calculator, where power consumption should be minimized, whereas the transmission type liquid crystal display is generally used in TV, a computer, a monitor, etc., where a large-screen and high-quality image display is required.

### SUMMARY OF CERTAIN INVENTIVE ASPECTS

One aspect is a liquid crystal display that improves contrast ratio. Another aspect is a liquid crystal display including: a lower substrate that is defined with a transmissive region and a reflective region and includes a reflecting layer formed in the reflective region, having a lens shape with a first concave part and a first convex part; an upper substrate that is defined with a transmissive region and a reflective region and includes a first overcoat layer formed in the reflective region, having a lens shape with a second concave part and a second convex part; and a liquid crystal layer that is positioned between the lower substrate and the upper substrate.

Exemplarily, the second concave part is positioned to face the first convex part and the second convex part is positioned to face the first concave part. The positions of the first concave part, the first convex part, the second concave part, and the second convex part are set to be coupled with each other without having a step when the first overcoat layer is matched with the reflecting layer to be overlapped. An organic layer in the lens shape is formed between the reflecting layer and the lower substrate. In the reflective region of the lower substrate, a common electrode, a pixel electrode, and a dielectric layer positioned between the common electrode and the pixel electrode are formed. The organic layer is formed at a first thickness and the dielectric layer is formed at a second thickness that is different from the first thickness. The first thickness is thicker than the second thickness. A color filter is formed on the transmissive region of the upper substrate. A second overcoat layer is further formed on the rear surface of the color filter to be opposite to the lower substrate. A backlight assembly that supplies light to the transmissive region is positioned on the rear surface of the lower substrate. The one reflective region and the one transmissive region form one sub pixel.

Another aspect is a liquid crystal display comprising: a lower substrate comprising a lower transmissive region and a lower reflective region, wherein a reflecting layer is formed in the lower reflective region, and wherein the reflective layer has a lens shape which comprises a first concave portion and a first convex portion; an upper substrate comprising an upper transmissive region and an upper reflective region, wherein a first overcoat layer is formed in the upper reflective region, and wherein the first overcoat layer has a lens shape which comprises a second concave portion and a second convex portion; and a liquid crystal layer positioned between the lower substrate and the upper substrate.

In the above display, the second concave portion faces the first convex portion, wherein the second convex portion faces the first concave portion, and wherein the distance between the first convex portion and the second concave portion is substantially the same as the distance between the first concave portion and the second convex portion.

In the above display, the first concave portion and the first convex portion are connected to each other, wherein the second concave portion and the second convex portion are connected to each other, wherein the first concave portion and the second convex portion are substantially aligned with each other along a direction extending from the lower substrate to the upper substrate, and wherein the first convex portion and the second concave portion are substantially aligned with each other along the direction.

The above display further comprises an organic layer in the lens shape formed between the reflecting layer and the lower substrate. The above display further comprises, in the transmissive region of the lower substrate, a common electrode; a pixel electrode; and a dielectric layer positioned between the common electrode and the pixel electrode.

In the above display, the organic layer has a first thickness and wherein the dielectric layer has a second thickness that is different from the first thickness. In the above display, the first thickness is greater than the second thickness. The above display further comprises a color filter formed on the transmissive region of the upper substrate.

The above display further comprises a second overcoat layer formed on a surface of the color filter to be opposite to the lower substrate, wherein the second overcoat layer is closer to the lower substrate than the color filter. The above display further comprises a backlight assembly configured to provide light to the transmissive region and positioned on a surface of the lower substrate, wherein the lower substrate is closer to the upper substrate than the backlight assembly. In the above display, the one reflective region and the one transmissive region form one sub pixel.

Another aspect is a liquid crystal display comprising: a first substrate configured to display an image; a second substrate, wherein each of the first and second substrates are separated into a transmissive region and a reflective region; a reflecting layer formed in the reflective region of the second substrate, wherein the reflecting layer comprises first and second surfaces opposing each other, and wherein each of the first and second surfaces has a first curved shape; a overcoat layer formed in the reflective region of the first substrate, wherein the overcoat layer comprises a first surface, wherein the first surface of the overcoat layer has a second curved shape which has substantially the same shape as the first curved shape, and wherein the second curved shape is substantially aligned with the first curved shape along a direction extending from the second substrate to the first substrate; and a liquid crystal layer interposed between the first and second substrates.

In the above display, the first and second curved shapes are substantially similar to a sinusoidal wave. In the above display, the overcoat layer comprises a second surface opposing the first surface thereof, and wherein the second surface of the overcoat layer has a substantially linear shape. In the above display, the first surface of the overcoat layer is closer to the reflecting layer than the second surface of the overcoat layer.

In the above display, the second surface of the overcoat layer contacts the first substrate. The above display further comprises an organic layer formed between the second substrate and overcoat layer, wherein the organic layer comprises a surface having a curved shape. In the above display, the first surface of the reflecting layer is closer to the first substrate than the second surface of the reflecting layer, and wherein the second surface of the reflecting layer contacts the surface of the organic layer.

Another aspect is a liquid crystal display comprising: a first substrate configured to display an image; a second substrate, wherein each of the first and second substrates are separated into a transmissive region and a reflective region; a reflecting layer formed in the reflective region of the second substrate, wherein the reflecting layer comprises first and second surfaces opposing each other, and wherein each of the first and second surfaces has a substantially sinusoidal wave shape; means for compensating a phase difference of the wavelength of light which passes through the reflecting layer, wherein the compensating means is formed at the first substrate; and a liquid crystal layer interposed between the first and second substrates.

In the above device, the compensating means has a substantially sinusoidal wave shape which is substantially aligned with the sinusoidal wave shape of the reflecting layer along a direction extending from the second substrate to the first substrate.

### BRIEF DESCRIPTION OF THE DRAWINGS

FIG. 1 is a diagram showing a liquid crystal display according to an embodiment of the present invention.

FIG. 2 is a diagram showing a phase difference of the reflective region of FIG. 1.

FIG. 3 is a diagram showing a pixel according to an embodiment of the present invention.

### DETAILED DESCRIPTION OF CERTAIN INVENTIVE EMBODIMENTS

A transflective liquid crystal display that has advantages of the reflection type and the transmission type to be able to secure suitable visibility has been recently developed in order to reduce power consumption and to implement a high-quality image.

Generally, the transflective liquid crystal display includes i) a lower substrate, ii) an upper substrate that is disposed opposite to the lower substrate, iii) a liquid crystal panel formed of a liquid crystal layer positioned between the lower substrate and the upper substrate, and iv) a backlight assembly that is disposed on the rear surface of the liquid crystal panel.

In order to improve the reflection efficiency of a reflective region, the transflective liquid crystal display forms a reflecting layer in a lens shape (that is, an embossed shape) having a concave part and a convex part. In this case, the reflection efficiency of the reflective region is improved, thereby making it possible to improve display quality.

However, when the reflecting layer is formed in a lens shape, the distance between the reflecting layer and the upper substrate changes according to positions in the reflecting layer. The distance differences create a phase difference of the wavelength of light which passes through the reflecting layer. This can increase the brightness of the dark zone (dark brightness) of the liquid crystal panel.

More specifically, in the transflective liquid crystal display, a minute cell gap control is an important factor to degrade the dark brightness. However, when the phase difference of the reflective region is changed according to positions, the cell gap is also changed according to positions so that the dark brightness is increased, thereby causing a problem that contrast ratio is degraded.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, exemplary embodiments of the present invention, proposed so that a person having ordinary skill in the art can easily carry out the embodiment, will be described in more detailed with reference to the accompanying FIG. 1 to FIG. 3.

FIG. 1 is a diagram showing a liquid crystal display according to an embodiment of the present invention. For convenience of explanation, a reflective region and a transmissive region included in one sub pixel will be shown in FIG. 1. And, the general constitution of the embodiment will be partially omitted in FIG. 1.

Referring to FIG. 1, the liquid crystal display according to the embodiment includes i) a lower substrate 100, ii) an upper substrate 200 that is positioned opposite to the lower substrate 100, iii) a liquid crystal layer 150 that is positioned between the lower substrate 100 and the upper substrate 200, and iv) a backlight assembly 300 that is positioned on the rear surface of the lower substrate 100. An image may be displayed through the upper substrate 200.

In one embodiment, a common electrode 110 is formed on a first side of the transmissive region of the lower substrate 100 and a dielectric layer 114 is formed on the common electrode 110. In one embodiment, a pixel electrode 120 is formed on the dielectric layer 114 so that it is positioned on a second side of the transmissive region. Herein, an alignment layer, not shown, may be additionally formed on the pixel electrode 120.

The common electrode 110 receives a predetermined current from the outside. The dielectric layer 114 is formed to isolate the gate electrode and the drain/source electrode of a TFT not shown.

The pixel electrode 120 receives a predetermined current from the TFT and controls the light transmittance of the liquid crystal layer 150 by corresponding to the supplied voltage. Herein, the pixel electrode 120 forms a predetermined electric field with the common electrode 110.

Meanwhile, although the structure of the transmissive region is shown in an IPS mode in FIG. 1, the embodiment is not limited thereto. The embodiment may relate to the structure of the reflective region so that the structure of the transmissive region may be constituted in various shapes that are currently well-known.

In one embodiment, an organic layer 112 is formed on the reflective region of the lower substrate 100, and a reflecting layer 116 is formed on the organic layer 112.

The organic layer 112 may be formed through, for example, coating, exposure, development, etc., and may be formed of a photosensitive material. In one embodiment, the organic layer 112 is formed to be thicker than the dielectric layer 114 so that the cell gap of the reflective region is set to be lower than the cell gap of the transmissive region. And, the organic layer 112 may be formed in a lens shape having a first concave part 117 and a first convex part 118.

The reflecting layer 116 is formed on the organic layer 112. In one embodiment, the reflecting layer 116 is formed of metal having excellent reflectance, such as aluminum, silver, or aluminum-molybdenum alloy. In one embodiment, the reflecting layer 116 is formed on the organic layer 112 in a lens shape so that it is also formed in a lens shape. The reflecting layer 116 may be formed to have a first concave part 117 and a first convex part 118 in the same manner as the organic layer 112. If the reflecting layer 116 is formed in a lens shape, the reflectance of the light supplied from the outside can be improved.

Herein, although only the organic layer 112 and the reflecting layer 116 are shown on the lower substrate 100 in the reflective region, the present invention is not limited thereto. The structure of the lower substrate 100 in the reflective region may be constituted in various shapes that are currently well-known.

In one embodiment, a color filter 210 is formed on the transmissive region of the upper substrate 200. The color filter 210 may give blue, green, or blue to the light supplied via the liquid crystal layer 150. Such a color filter 210 may be commonly formed of a photosensitive organic material.

In one embodiment, an overcoat layer 220 (or a second overcoat layer) is formed on the rear surface of the color filter 210. The overcoat layer 220 may be formed to be opposite to the lower substrate 100, having the liquid crystal layer 150 therebetween. Such an overcoat layer 220 serves to protect the color filter 210. Meanwhile, the overcoat layer 220 may be omitted, if necessary.

In the explanation as described above, only the color filter 210 and the overcoat layer 220 are shown on the upper substrate 200 in the transmissive region. However, at least one other element such as an alignment layer may be additionally formed on the rear surface of the overcoat layer 220. The embodiment may relate to the structure of the reflective region so that the structure of the transmissive region may be constituted in various other shapes.

In one embodiment, an overcoat layer 230 (or a first overcoat layer) is formed on the reflective region of the upper substrate 200. The overcoat layer 230 may be formed on a position opposite to the lower substrate 100, having the liquid crystal layer 150 therebetween. The overcoat layer 230 may be formed through, for example, the coating, exposure, development, etc., and may be formed of a photosensitive material. At least one surface of the overcoat layer 230 may be formed in a lens shape having a second concave part 231 and a second convex part 232. In another embodiment, means for compensating a phase difference of the wavelength of light which passes through the reflecting layer 116 may be provided. The compensating means may include one or more overcoat layers. The compensating means may include at least one overcoat layer and at least one other layer.

In one embodiment, the second concave part 231 is formed to face the first convex part 118, and the second convex part 232 is formed to face the first concave part 117. The second concave part 231 and the second convex part 232 may be formed to be coupled with each other without having a step when the overcoat layer 230 is matched with the organic layer 112 (or the reflecting layer) to be overlapped. In one embodiment, the first concave part 117 and the second convex part 232 are substantially aligned with each other along a direction extending from the lower substrate 100 to the upper substrate 200, and wherein the first convex part 118 and the second concave part 231 are substantially aligned with each other along the direction.

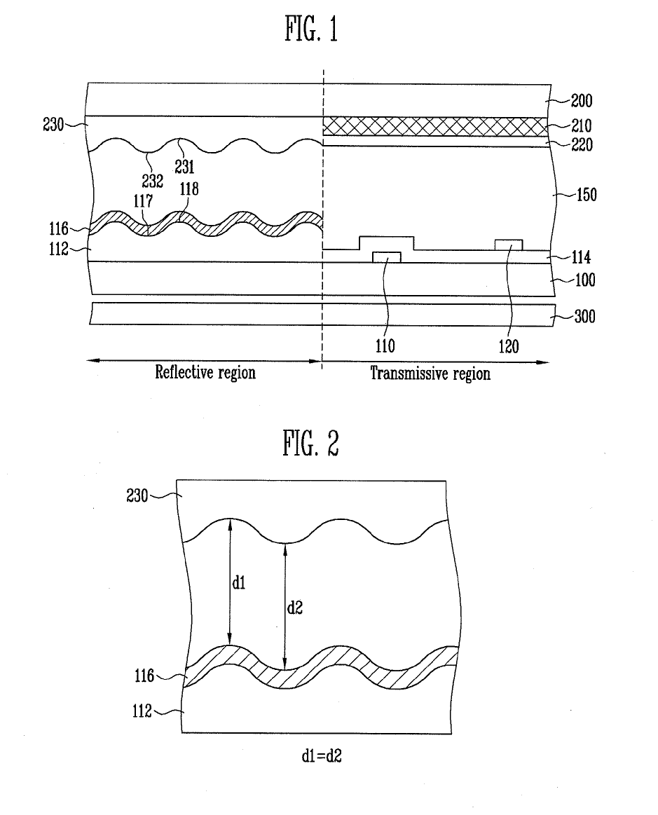

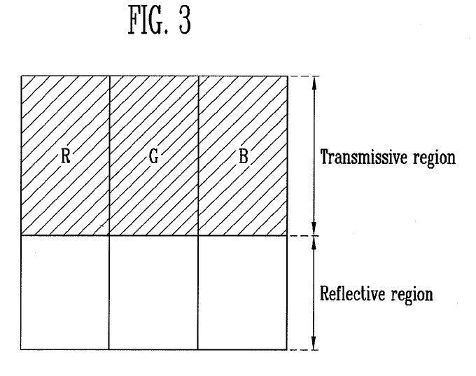

In this embodiment, the phase difference d1 and d2 can be constantly maintained irrespective of the position of the reflective region, as shown in FIG. 2. If the phase difference d1 and d2 is constantly maintained in the reflective region as described above, dark brightness can be reduced and thus contrast ratio can be improved.

Meanwhile, in the above description, only the overcoat layer 230 is shown on the upper substrate 200 of the reflective region. However, at least one other element such as an alignment layer, etc., may be additionally formed on the rear surface of the overcoat layer 230. Also, a color filter not shown may be additionally formed between the overcoat layer 230 and the upper substrate 200 in order to represent color. The reflective region may be constituted in various other shapes, as long as the overcoat layer 230 includes a lens shape surface.

The liquid crystal layer 150 may limit the amount of light transmitting itself so that a predetermined image can be displayed.

The backlight assembly 300 generates a predetermined light to supply it to the transmissive region. Such a backlight assembly 300 may include at least one of a light source, a light guide plate and an optical film, etc., not shown.

Table 1 shows the simulation result of contrast ratio between the embodiment where both the lower substrate and the upper substrate are formed in a lens shape in the reflective region and the related art where only the lower substrate is formed in a lens shape.

TABLE 1

| | Comparative | |
|---|---|---|
| | example | embodiment example |
| Contrast ratio | 17:1 | 300:1 |

Referring to FIG. 1, the comparative example has the contrast of 17:1 but an example according to one embodiment has the contrast ratio of 300:1. Therefore, the embodiment example can significantly improve display quality compared to the comparative example.

Meanwhile, the contrast ratio may generally be changed due to the bonded distortion when boding the upper substrate 200 to the lower substrate 100. Table 2 shows the contrast ratio corresponding to the bonded distortion when the distance between a specific first convex part 118 and a first convex part 118 adjacent thereto is set to 12 μm.

TABLE 2

| | Bonded distortion | | | | | | |
|---|---|---|---|---|---|---|---|
| | 0 μm | 1 μm | 2 μm | 3 μm | 4 μm | 5 μm | 6 μm |
| Contrast ratio | 300:1 | 275:1 | 97:1 | 45:1 | 27:1 | 20:1 | 17:1 |

Referring to FIG. 2, it can be appreciated that as the bonded distortion becomes large, the contrast ratio is lowered. Generally, the bonded distortion between the upper substrate 200 and the lower substrate 100 is determined to be within about 3 μm. Therefore, the embodiment has a high contrast ratio compared to the comparative example, irrespective of the bonded distortion.

FIG. 3 is a diagram showing a pixel that includes red, green and blue sub pixels according the embodiment of the present invention.

Referring to FIG. 3, in one embodiment, the respective sub pixels include the transmissive region and the reflective region. A predetermined color image may be displayed, while controlling the amount of light supplied from the backlight assembly 300 in the transmissive region. Such a transmissive region may be used in displaying a main image to be displayed.

The reflective region may display a predetermined image, while reflecting the natural light supplied from the outside. Such a reflective region may be used in displaying predetermined logos or characters, etc., on a standby screen, etc. Herein, the reflective region may display a predetermined image, while being driven simultaneously with the transmissive region.

According to at least one embodiment, the overcoat layer positioned on the reflective region and formed on the upper substrate is formed in a lens shape, making it possible to constantly maintain the phase difference of the reflective region. Therefore, embodiments can degrade the dark brightness and thus can improve the contrast ratio.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A liquid crystal display comprising:
a lower substrate comprising a lower transmissive region and a lower reflective region, wherein a reflecting layer is formed in the lower reflective region, and wherein the reflective layer has a lens shape which comprises a first concave portion and a first convex portion;
an upper substrate comprising an upper transmissive region and an upper reflective region, wherein a first overcoat layer is formed in the upper reflective region, and wherein the first overcoat layer has a lens shape which comprises a second concave portion and a second convex portion; and
a liquid crystal layer positioned between the lower substrate and the upper substrate.

2. The liquid crystal display as claimed in claim 1, wherein the second concave portion faces the first convex portion, wherein the second convex portion faces the first concave portion, and wherein the distance between the first convex portion and the second concave portion is substantially the same as the distance between the first concave portion and the second convex portion.

3. The liquid crystal display as claimed in claim 1, wherein the first concave portion and the first convex portion are connected to each other, wherein the second concave portion and the second convex portion are connected to each other, wherein the first concave portion and the second convex portion are substantially aligned with each other along a direction extending from the lower substrate to the upper substrate, and wherein the first convex portion and the second concave portion are substantially aligned with each other along the direction.

4. The liquid crystal display as claimed in claim 1, further comprising an organic layer in the lens shape formed between the reflecting layer and the lower substrate.

5. The liquid crystal display as claimed in claim 4, further comprising, in the transmissive region of the lower substrate,
a common electrode;
a pixel electrode; and
a dielectric layer positioned between the common electrode and the pixel electrode.

6. The liquid crystal display as claimed in claim 5, wherein the organic layer has a first thickness and wherein the dielectric layer has a second thickness that is different from the first thickness.

7. The liquid crystal display as claimed in claim 6, wherein the first thickness is greater than the second thickness.

8. The liquid crystal display as claimed in claim 1, further comprising a color filter formed on the transmissive region of the upper substrate.

9. The liquid crystal display as claimed in claim 8, further comprising a second overcoat layer formed on a surface of the color filter to be opposite to the lower substrate, wherein the second overcoat layer is closer to the lower substrate than the color filter.

10. The liquid crystal display as claimed in claim 1, further comprising a backlight assembly configured to provide light to the transmissive region and positioned on a surface of the lower substrate, wherein the lower substrate is closer to the upper substrate than the backlight assembly.

11. The liquid crystal display as claimed in claim 1, wherein the one reflective region and the one transmissive region form one sub pixel.

12. A liquid crystal display comprising:
a first substrate configured to display an image;
a second substrate, wherein each of the first and second substrates are separated into a transmissive region and a reflective region;
a reflecting layer formed in the reflective region of the second substrate, wherein the reflecting layer comprises first and second surfaces opposing each other, and wherein each of the first and second surfaces has a first curved shape;
a overcoat layer formed in the reflective region of the first substrate, wherein the overcoat layer comprises a first surface, wherein the first surface of the overcoat layer has a second curved shape which has substantially the same shape as the first curved shape, and wherein the second curved shape is substantially aligned with the first curved shape along a direction extending from the second substrate to the first substrate; and
a liquid crystal layer interposed between the first and second substrates.

13. The liquid crystal display as claimed in claim 12, wherein the first and second curved shapes are substantially similar to a sinusoidal wave.

14. The liquid crystal display as claimed in claim 12, wherein the overcoat layer comprises a second surface opposing the first surface thereof, and wherein the second surface of the overcoat layer has a substantially linear shape.

15. The liquid crystal display as claimed in claim 14, wherein the first surface of the overcoat layer is closer to the reflecting layer than the second surface of the overcoat layer.

16. The liquid crystal display as claimed in claim 14, wherein the second surface of the overcoat layer contacts the first substrate.

17. The liquid crystal display as claimed in claim 12, further comprising an organic layer formed between the second substrate and overcoat layer, wherein the organic layer comprises a surface having a curved shape.

18. The liquid crystal display as claimed in claim 17, wherein the first surface of the reflecting layer is closer to the first substrate than the second surface of the reflecting layer, and wherein the second surface of the reflecting layer contacts the surface of the organic layer.

19. A liquid crystal display comprising:
a first substrate configured to display an image;
a second substrate, wherein each of the first and second substrates are separated into a transmissive region and a reflective region;
a reflecting layer formed in the reflective region of the second substrate, wherein the reflecting layer comprises first and second surfaces opposing each other, and wherein each of the first and second surfaces has a substantially sinusoidal wave shape;
means for compensating a phase difference of the wavelength of light which passes through the reflecting layer, wherein the compensating means is formed at the first substrate; and
a liquid crystal layer interposed between the first and second substrates.

20. The liquid crystal display as claimed in claim 19, wherein the compensating means has a substantially sinusoidal wave shape which is substantially aligned with the sinusoidal wave shape of the reflecting layer along a direction extending from the second substrate to the first substrate.
